(19) United States
(12) Patent Application Publication
(10) Pub. No.: US 2019/0355037 A1
(43) Pub. Date: Nov. 21, 2019

(54) SYSTEMS AND METHODS OF CONNECTING CUSTOMERS TO JEWELRY RETAILERS VIA MOBILE OR DESKTOP APPLICATIONS TO CREATE CUSTOM DESIGNS AND FACILITATE REAL TIME COLLABORATION WITH RETAILERS

(71) Applicant: Star Gems, Inc., Norcross, GA (US)

(72) Inventor: Anish Desai, Norcross, GA (US)

(21) Appl. No.: 16/527,539

(22) Filed: Jul. 31, 2019

Related U.S. Application Data
(63) Continuation of application No. PCT/US18/18314, filed on Feb. 15, 2018.
(60) Provisional application No. 62/473,745, filed on Mar. 20, 2017.

(51) Int. Cl. G06Q 30/06; A44C 27/00; G06F 16/955

(52) U.S. Cl. CPC G06Q 30/0621; G06F 16/955; G06Q 30/0629; A44C 27/00

(57) ABSTRACT

The subject matter described herein includes a design aggregation server including a processor and a memory. The server is configured for receiving a plurality of jewelry designs from one or more jewelry designers. The server associates characteristics of the plurality of designs into a design database, receives an image, input, or design from a retailer or potential customer, compares the received image, input, or design with the plurality of designs at the design database, and provides one or more pricing characteristics to the retailer or the customer based on the comparison.

### CROSS-REFERENCE TO RELATED APPLICATIONS

The present application is a continuation of International Patent Application No. PCT/US2018/018314 titled “SYSTEMS AND METHODS OF CONNECTING CUSTOMERS TO JEWELRY RETAILERS VIA MOBILE OR DESKTOP APPLICATIONS TO CREATE CUSTOM DESIGNS AND FACILITATE REAL TIME COLLABORATION WITH RETAILERS, filed on Feb. 15, 2018, which claims priority to and benefit from U.S. Provisional Patent Application Ser. No. 62/473,745 titled “SYSTEMS AND METHODS OF CONNECTING CUSTOMERS TO JEWELRY RETAILERS VIA MOBILE OR DESKTOP APPLICATIONS TO CREATE CUSTOM DESIGNS AND FACILITATE REAL TIME COLLABORATION WITH RETAILERS”, filed on Mar. 20, 2017, the contents of all of which are incorporated by reference herein.

### TECHNICAL FIELD

The presently disclosed subject matter is generally directed to systems and methods of designing and manufacturing jewelry. Specifically, embodiments of the present disclosure relate to a system and method for designing, pricing, and manufacturing jewelry, linking designers with manufacturers, and facilitating collaboration between designers, manufacturers, and dealers.

### BACKGROUND

When a customer designs custom jewelry, they must usually wait a lengthy period of time in order to receive proofs of the design and a cost estimate. For a retailer, this time period results in increased overhead, reduced closings and sales, cost uncertainty, and customer dissatisfaction. The customer may instead choose to purchase a stock item, which has lower profit margins due to increased pricing competition, or may be unwilling to wait for the pricing, design work, and completion of the final product. Accordingly, a need exists for a system that addresses these issues.

In one embodiment of the currently disclosed subject matter the end user or customer is able to design a ring from their mobile device and instantly send the design order to their personal jewelry retailer. This embodiment streamlines the process and documents each step of the transaction; which is recorded on a server creating a data trail until the order is fully executed and paid for via an application.

The retailer can manufacture the jewelry themselves, or outsource the manufacturing to a third-party manufacturer. The third party can be any entity including the provider of the application service. If the retailer manufactures the jewelry themselves, they may pay a commission to the provider of the application service. This commission may be paid once the customer pays for the jewelry. The royalty is paid to the provider of the application service for creating the platform upon which the retailer and customer conduct their business.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

Disclosed herein is a design aggregation server including a processor and a memory. The server is configured for receiving a plurality of jewelry designs from one or more jewelry designers. The server associates characteristics of the plurality of designs into a design database, receives an image, input, or design from a retailer or potential customer, compares the received image, input, or design with the plurality of designs at the design database, and provides one or more pricing characteristics to the retailer or the customer based on the comparison.

According to one or more embodiments, the designers are assigned a reference code based on geographic location.

According to one or more embodiments, the customer is assigned a reference code based on geographic location.

According to one or more embodiments, the retailer is assigned a reference code based on geographic location.

According to one or more embodiments, the reference code contains nine digits.

According to one or more embodiments, the first two digits of the reference code represent a country code corresponding with the geographic location of the retailer and the next three digits represent an area code corresponding with the geographic location of the retailer.

According to one or more embodiments, the server is further configured for transmitting the image, input, or design to at least one manufacturer capable of producing jewelry.

According to one or more embodiments, the server also includes an application platform having a user interface configured for designing jewelry.

According to one or more embodiments, a method implemented on at least one server for providing pricing characteristics to retailers includes receiving a plurality of jewelry designs from one or more jewelry designers, associating characteristics of the plurality of designs into a design database, receiving an image, input, or design from a retailer or potential customer, comparing the received image, input, or design with the plurality of designs at the design database, and providing one or more pricing characteristics to the retailer or the customer based on the comparison.

According to one or more embodiments, the designers are assigned a reference code based on geographic location.

According to one or more embodiments, the customer is assigned a reference code based on geographic location.

According to one or more embodiments, the retailer is assigned a reference code based on geographic location.

According to one or more embodiments, the reference code contains nine digits.

According to one or more embodiments, the first two digits of the reference code represent a country code corresponding with the geographic location of the retailer and the next three digits represent an area code corresponding with the geographic location of the retailer.

According to one or more embodiments, the server is further configured for transmitting the image, input, or design to at least one manufacturer capable of producing jewelry.

According to one or more embodiments, the method also includes an application platform having a user interface configured for designing jewelry.

According to one or more embodiments, a method of facilitating collaboration between designers, manufactures, and retailers for manufacturing and selling jewelry includes receiving a jewelry design created on an application platform interface from a customer or designer, receiving design specifications through the interface to a design aggregation server from the customer or designer, communicating the specifications to at least one manufacturer, and receiving pricing data and a modified specification from the at least one manufacturer.

The modified specification and pricing are communicated to the customer or designer. A piece of jewelry is manufactured based on the modified specification. The manufactured piece of jewelry is shipped to the retailer or designer for selling or displaying.

According to one or more embodiments, the method also includes coupling to a mobile device or computer capable of rendering the application platform interface.

According to one or more embodiments, the method also includes rejecting the design created by the customer on the application platform interface.

According to one or more embodiments, the method also includes transmitting the modified specification from the design aggregation server to the designer over the application platform interface.

According to one or more embodiments, the manufactured piece of jewelry is shipped directly to the customer.

According to one or more embodiments, the customer uses the application platform interface to pay for the piece of jewelry.

According to one or more embodiments, a method of associating terminology with design features of jewelry includes recording search terms from a plurality of users on an application platform interface, tracking the navigation of each user throughout the application, recording the final selection of jewelry chosen by each user, associating the search terms from each user with the design features of the final selection of jewelry chosen by each user, detecting a pattern of user behavior among the plurality of users, and creating a database of search terms and correlating the search terms with particular design features of jewelry based on the detected pattern of user behavior.

According to one or more embodiments, the method also includes storing the database of search terms on a design aggregation server.

According to one or more embodiments, detecting a pattern of user behavior includes storing a first user's search terms on a design aggregation server, storing a second user's search terms on the design aggregation server, storing, on the design aggregation server, design features related to the first user's final selection of jewelry, storing, on the design aggregation server, design features related to the second user's final selection of jewelry, comparing design features related to the first user's final selection of jewelry, with design features related to the second user's final selection of jewelry, determining commonalities between the two users' design features, comparing the first user's search terms with the second user's search terms, determining commonalties between the two users' search terms, determining a correlation between the design feature commonalities and the search term commonalities, and storing the correlation on the design aggregation server.

According to one or more embodiments, the method also includes receiving search terms from a third user through the application platform interface, wherein the interface is communicatively coupled to the design aggregation server, comparing the search terms from the third user against the correlation, and determining which design features are most relevant to the third user.

### BRIEF DESCRIPTION OF THE DRAWINGS

The foregoing, as well as the following Detailed Description of preferred embodiments, is better understood when read in conjunction with the appended drawings. For the purposes of illustration, there is shown in the drawings exemplary embodiments; however, the presently disclosed subject matter is not limited to the specific methods and instrumentalities disclosed.

The embodiments illustrated, described, and discussed herein are illustrative of the present invention. As these embodiments of the present invention are described with reference to illustrations, various modifications or adaptations of the methods and or specific structures described may become apparent to those skilled in the art. It will be appreciated that modifications and variations are covered by the above teachings and within the scope of the appended claims without departing from the spirit and intended scope thereof. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

FIG. 1A is a flowchart of the system according to one or more embodiments of the presently disclosed subject matter.

FIG. 1B illustrates a screen shot of a mobile application according to one or more embodiments of the presently disclosed subject matter.

FIG. 2 illustrates a system diagram according to one or more embodiments of the presently disclosed subject matter.

FIG. 3 illustrates a flowchart of the system according to one or more embodiments of the presently disclosed subject matter.

FIG. 4 illustrates a flow diagram according to one or more embodiments of the presently disclosed subject matter.

FIG. 5 is a screen shot of the application platform interface according to one or more embodiments of the presently disclosed subject matter.

FIG. 6 is a screen shot of the application platform interface according to one or more embodiments of the presently disclosed subject matter.

FIG. 7 is a screen shot of the application platform interface according to one or more embodiments of the presently disclosed subject matter.

FIG. 8 is a screen shot of the application platform interface according to one or more embodiments of the presently disclosed subject matter.

FIG. 9 is a screen shot of the application platform interface according to one or more embodiments of the presently disclosed subject matter.

FIG. 10 is a screen shot of the application platform interface according to one or more embodiments of the presently disclosed subject matter.

FIG. 11 is a screen shot of the application platform interface according to one or more embodiments of the presently disclosed subject matter.

FIG. 12 is a screen shot of the application platform interface according to one or more embodiments of the presently disclosed subject matter.

FIG. 13 is a screen shot of the application platform interface according to one or more embodiments of the presently disclosed subject matter.

FIG. 14 is a screen shot of the application platform interface according to one or more embodiments of the presently disclosed subject matter.

FIG. 15 is a screen shot of the application platform interface according to one or more embodiments of the presently disclosed subject matter.

### DETAILED DESCRIPTION

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the presently disclosed subject matter.

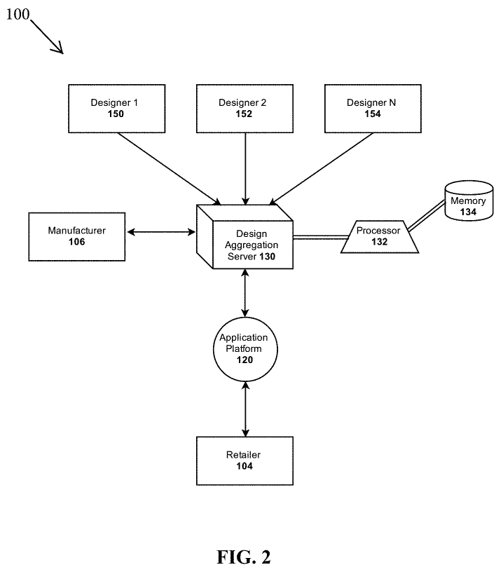

With reference now to FIG. 2, a system is provided herein. The system 100 includes a design aggregation server 130, a processor 132, a memory 134 and an application platform interface 120. The system may also include a plurality of designers illustrated by reference numbers 150, 152, and 154. The system may also include a manufacturer 106 and a retailer 104.

In the presently disclosed subject matter the terms “manufacturer”, “vendor”, “retailer”, “designer”, and “dealer” may be used interchangeably. They may be the same or different entities. In the presently disclosed subject matter the terms “customer”, “consumer” and “designer” may be used interchangeably. They may be the same or different entities. The terms “website”, “application”, “platform”, and “interface” are sometimes used interchangeably when describing the customer interface. They may represent the same or different aspects of the presently disclosed subject matter.

In some embodiments of the presently disclosed subject matter a web-based, downloadable, or mobile application system is used by a designer or a plurality of designers. The application has the ability to communicate over wired or wireless networks. The designers may be independent professionals. The designers may use this system to design jewelry. The end user or customer may also be the designer if the customer has downloaded the application and is linked with a retailer. The customer links with a retailer by entering the retailer's personalized nine digit reference code that is provided to the customer through advertising, or by direct contact at the retailers physical store. The reference code can be any combination of numbers, letters, and symbols sufficient to distinguish one retailer from another.

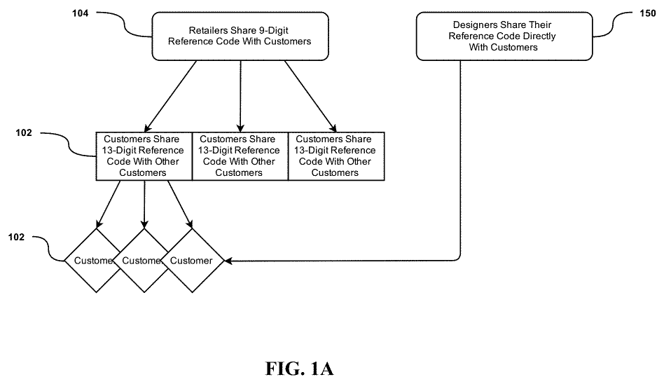

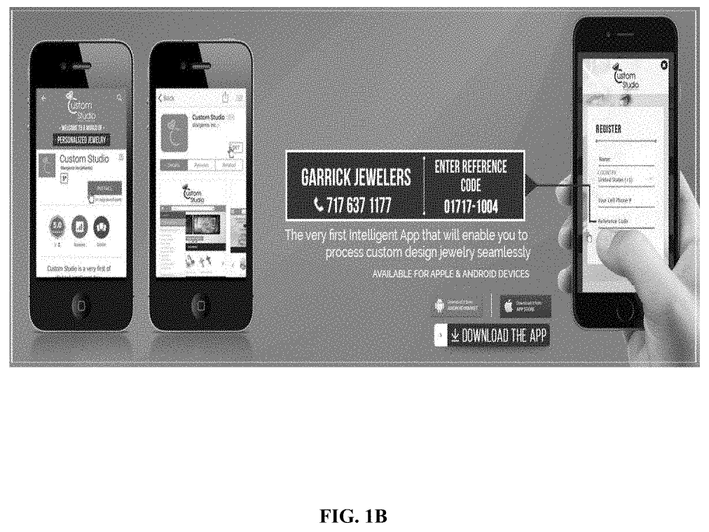

FIG. 1A illustrates one embodiment of how reference codes may be shared between retailers and customers or between two or more customers. In one embodiment retailers 104 share their 9-digit reference codes with customers 102. The customers 102 may share their 13-digit reference codes with other customers. Additionally the designer 150 may share their reference code directly with customers 102.

The jewelry retailer obtains a nine digit reference code when they become a paid subscriber to the application. In another embodiment of the currently disclosed subject matter, the retailer's reference code can contain any number of digits sufficient to distinguish one retailer from another.

In one embodiment of the currently disclosed subject matter the first two digits of the retailers personalized reference code match the country code of the dealer's location. For example if the retailer is located in the United States their reference code will begin with the numbers 01, if the retailer is located in India their reference code will begin with the numbers 91. The next three digits of the retailer's reference code are determined by the area code where the retailer is located. For example a retailer located in Northern Georgia in the United States may have a reference code of 01770-xxxx where 770 is the area code corresponding with the dealers physical location.

Customers are also assigned a thirteen digit reference code once they download the application and link with a retailer. In another embodiment, the customer's reference code can contain any number of digits sufficient to distinguish one customer from another. If a customer does not enter a reference code for a retailer, a retailer will be assigned to them based on geographic location. If a customer has their location services disabled on their mobile device, the app will assign a retailer to them based on the area code of the mobile device used to download the app, or any other geographical indicator available to the app.

In one embodiment of the currently disclosed subject matter, a customer can share their reference code with different customers who will be automatically linked with the same retailer. The retailer may choose to offer the original customer a promotional code, discount, or other bonus incentive for each customer they refer to the retailer. The retailer may also choose to create a rewards program to incentivize customers to refer other customers to them using the application and reference codes.

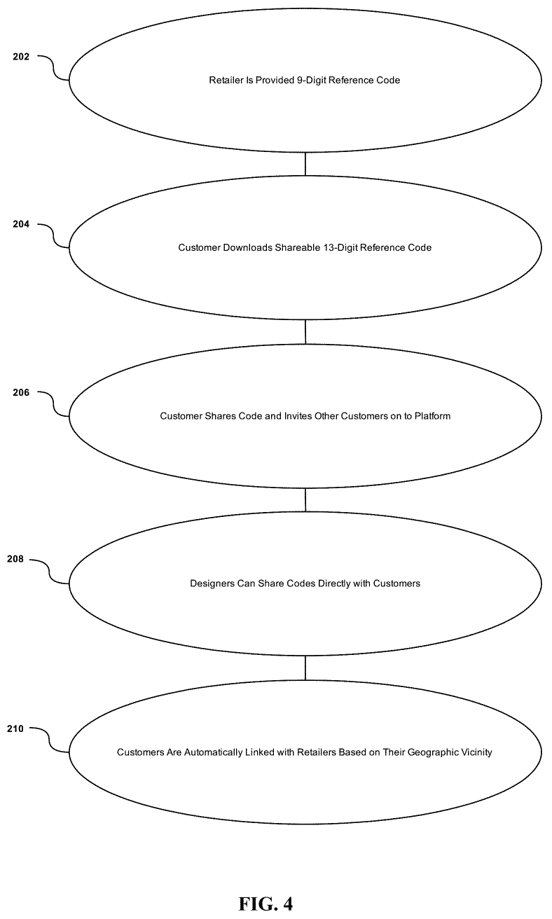

FIG. 4 illustrates different embodiments of a code sharing system. In step 202 the retailer is provided a 9-digit reference code. In step 204 the customer downloads a shareable 13-digit reference code. In step 206 the customer shares their reference code and invites other customers onto the application platform. In step 208 the designers can share their codes directly with customers if the customer has a particular interest in that designers work. In embodiment 210 customers are automatically linked with retailers based on their geographic vicinity to the retailer. There is no particular order to these steps and the absence of one or more steps is not fatal to the code sharing system of the presently disclosed subject matter.

Once a customer uses the app to design a piece of jewelry, and places an order with the linked retailer, the retailer has two options. The retailer can either manufacture the piece themselves, and pay a royalty to the application service provider for using the application to generate business, or they can outsource the manufacturing to a third-party manufacturer and charge the customer a mark-up once the jewelry is manufactured. The retailer will often make this determination based on the retailer's capabilities and the intricacies and quantity of jewelry to be designed. It is envisioned that the third-party manufacturer may also be the provider of this application service.

The retailer may also design their own jewelry to be manufactured by a third-party manufacturer. The jewelry will then be offered for sale on the retailer's application platform. Optionally, the jewelry may be offered on other retailers' platforms. Every time a sale takes place, the retailer/designer is paid a commission for designing the jewelry.

In one embodiment of the currently disclosed subject matter, an outside designer can submit a jewelry design directly to the third-party manufacturer. In this case the designer submits CAD drawings and other specifications to the manufacturer; giving sufficient detail for the manufacturer to determine if the design is feasible. The manufacturer can then sell jewelry, based on this design, on all the platforms of subscribed retailers. The manufacturer then pays the outside designer a commission every time a piece based on the design is sold.

Once a design is submitted by a customer, retailer, or designer, the application software automatically compares the submitted design to an existing database of designs to instantly find the closest match for purposes of pricing the submitted design. This allows a customer, retailer, or designer to immediately know the precise cost of their design. Based on this price they can substitute, for example, materials or gemstones and recalibrate the price by using the application software.

In one embodiment of the presently disclosed subject matter, the retailer can use the application platform interface to watch the customer or designer design the jewelry in real time. They can watch the design being created live, even before the design is submitted through the platform for a manufacturing or pricing query.

An outside designer may be given a designer reference code in order to interact with the application platform. The designer code may also be based on the designer's area code. If a customer is interested in a certain designer they may enter the designer's reference code into the application and be linked to a retailer who sells the designer's pieces. The customer may obtain the designer's reference code through advertisements such as the designer's social media pages.

The manufacturer collects geographic and sales information about retailers, customers, and designers. The manufacturer uses this information, for example, to help retailers target popular designs to certain demographics of customers. The manufacturer also uses geographic information to help link customers with retailers and designers; using reference codes that incorporate their area codes.

In some embodiments of the presently disclosed subject matter a web-based, downloadable, or mobile application system is used by a retailer or a plurality of retailers. The retailers may be independent professionals. The retailers may use this system to design jewelry. The retailers may have to be a paid subscriber to access the database.

The designers or consumers may use this system to submit jewelry designs through an online portal. In other embodiments the design can be created offline and later uploaded through the online portal. In one embodiment the design submitted may be based on a determination of acceptable or already available designs. The customer may edit existing designs on the platform; use a sketch pad application to create new designs on the platform; or import outside images to the platform, and edit those images directly on the platform using the application.

FIG. 2 illustrates a system diagram according to one embodiment of the presently disclosed subject matter. As shown in FIG. 2, multiple designers submit their designs which are stored in the design aggregation server. The retailer may use the platform to communicate an interest in these designs to the manufacturer. The manufacturer may also link with retailers to distribute the designs once the jewelry is manufactured.

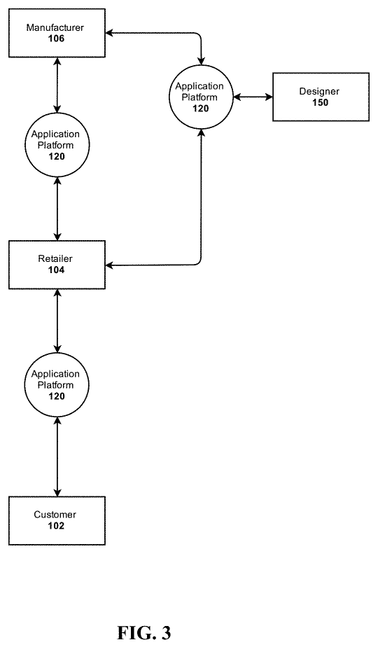

An example of the communication scheme between various parties is illustrated in FIG. 3. The customer 102 may message the retailer 104 directly using the application platform interface 120. The customer 102 can design jewelry using the application platform interface 120. The customer 102 may also pay for the jewelry using the interface 120. A manufacturer 106 may use the application platform interface to communicate jewelry design specification changes to the designer 150 and also to the retailer 104.

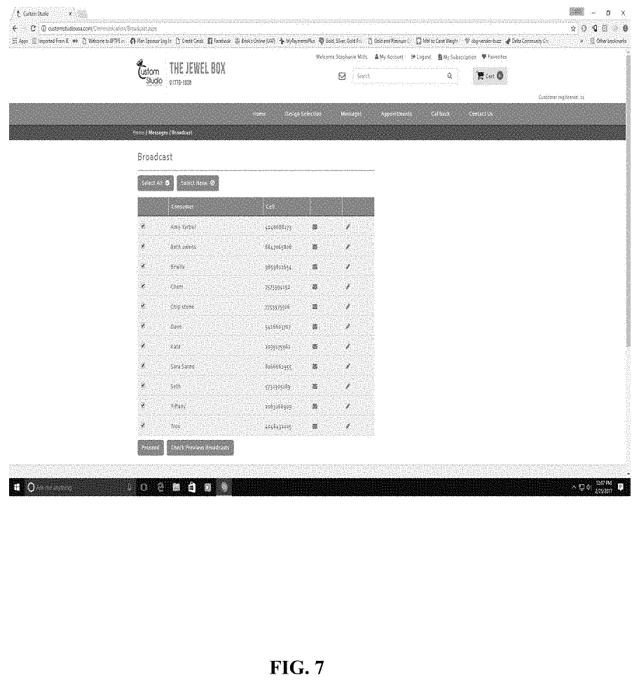

The retailer 104 can broadcast a mass message to all customers who are linked through the retailer's reference code using the application platform 120. The retailer 104 may also communicate directly with a single customer 102 using the application platform 120. A screen shot of this functionality is illustrated in FIG. 7.

Examples of how different reference codes may be used are illustrated in FIG. 4.

The system may include a plurality of designers 150, 152, 154 that communicate over a network with a design aggregation server 130. The designers may each work at a mobile terminal or workstation and present designs for consideration to the design aggregation server. Accompanying the design may include an image, either actual or a depiction, of the design, metal and gem characteristics of the design, size characteristics, pricing characteristics, time to completion characteristics, and similar.

The design aggregation server 130 may include a memory 134 and a processor 120 and be configured for receiving designs from the designer. Additionally, a manufacturer 106 may be able to view designs from the designer 150 and offer a manufactured cost for each design. A reverse auction system may additionally be employed. A reverse auction is a type of auction in which the roles of buyer and seller are reversed. In this situation, manufacturers may compete to obtain business from the designer and prices will typically decrease as the manufactures underbid each other.

Applications enabled at the retailer system such as a Point of Sale system may allow the retailer 104 and/or customer 102 to view the designs. Additionally, the customer 102 may provide their own design. The design aggregation server 130 may be configured to receive information from the customer 102 or retailer 104 about the design, metal or gem characteristics of the design, size characteristics, and the like. The design aggregation server may then be further configured to compare the received information with a database of received designs from designers to find a closely corresponding match. With the closely corresponding match, the retailer can then make some data-based assumptions about cost, time to completion, and the like. Additionally, in one or more embodiments, the data aggregation server may be configured to receive an image or similar, or to capture an image of a design, and compare to the database of received designs. Alternatively, an application may be provided at a computing device either at a Point of Sale retail location or on a mobile device, computer, or the like that allows the person to enter information related to a desired jewelry design.

Once a manufacturer or a retailer receives and evaluates the design, the manufacturer determines several factors before beginning the manufacturing process. The manufacturer may consider whether the design can be made, possible design changes for manufacturing purposes, and pricing considerations. The manufacturer may then proceed with the original design, or suggest changes to the design. The designer may accept or reject the manufacturer's changes, choose a different manufacturer, or abandon the design. Once the manufacturer receives a request from the retailer, the manufacturer provides a price quote. Once that price quote is approved, usually with some form of a deposit, the manufacturer proceeds to create the design. The design renderings can be redone to the customer's specifications and the order is processed once it is approved by the customer. All of the design changes can be handled by the customer through the application platform. This allows the customer to make changes to the design prior to finalization.

In one embodiment of the currently disclosed subject matter, the customer has the ability to modify a design based on a collection of designs provided by the application. In another embodiment there is a database of designs, and the software application auto compares the customer design to the database to find a closest match for pricing purposes. These features may be carried out on a web-based or downloadable application. The application has the ability to communicate over wired or wireless networks.

A designer or customer may choose a manufacturer or retailer of their preference. In other embodiments, if the designer does not suggest a retailer, the retailer may be chosen for them by the application based on geographic proximity or other considerations for example size and characteristics of the jewelry.

The application may receive input from the dealer such as queries based on size and characteristics of the jewelry. In response to the dealer input, the application displays various designs and provides instant pricing to the customer at the web page. These features may be carried out on a web-based or downloadable application. The application has the ability to communicate over wired or wireless networks.

On placement of the order, the manufacturer produces the product. In one embodiment of the currently disclosed subject matter the manufacturer may send a prototype of the design to the customer.

In some embodiments of the currently disclosed subject matter, the dealer may offer a designer's pieces to other customers on the website. The dealer may share a percentage of revenue with the designer based on purchases related to that designer's jewelry. In other embodiments the dealer may share a percentage of revenue with multiple parties.

As customers using the application platform search for specific styles or designs of jewelry, a smart inbuilt search algorithm is employed which self-learns searches based on previous searches. A designer starts getting more relevance if their design is popular, or searched for more times than other designs. If the design gains enough popularity, it may be converted into a brand by the manufacturer or retailer

The intelligent search algorithm works by linking designs that are eventually browsed with the search terms used to initially find these designs. The intelligent search algorithm then makes these terms relevant to these designs, so that when these terms are searched in the future, the relevant results displayed include these designs.

The application facilitates communication and real-time collaboration between customers and dealers by providing, for example, internal messaging, notifications, SMS, and WHATSAPP (R) type functionality. The application provides seamless communication between the customer, retailer, manufacturer, and designer.

In some embodiments of the presently disclosed subject matter, a manufacturer collects a series of jewelry designs from predominantly independent professionals that submit their designs through the application platform. The designs are then categorized according to design parameters.

The manufacturer then determines several factors, such as whether the design can be made, possible design changes for manufacturing purposes, and pricing considerations, before reaching a final determination as to the feasibility of project.

At the retailer's platform interface, the retailer receives input from a customer and then displays various design choices to the customer. Since the pricing information is already known, the retailer is able to instantaneously price the design for the customer. Once an order is placed, the manufacturer produces the product and may send a percentage of revenue to the designer. In some embodiments, additional royalties may be paid out to other entities.

Disclosed below are screen shots showing one or more embodiments of an application executing on a computing device associated with the system disclosed herein.

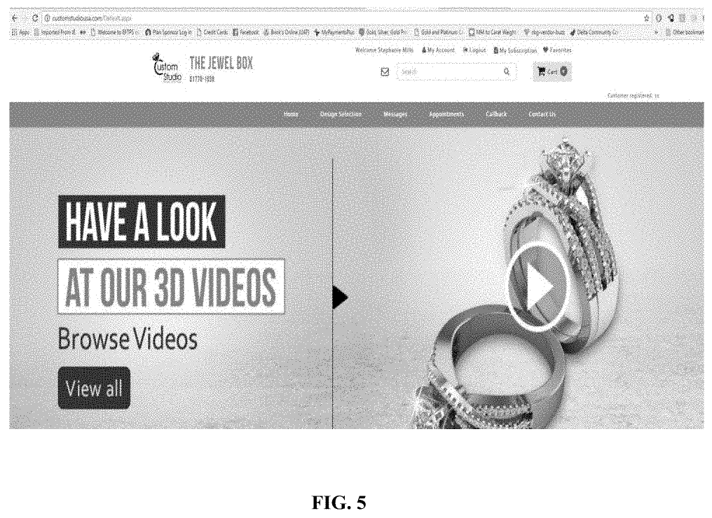

FIG. 5 is a view of the welcome screen displaying a retailer's name and a retailer's nine digit reference code.

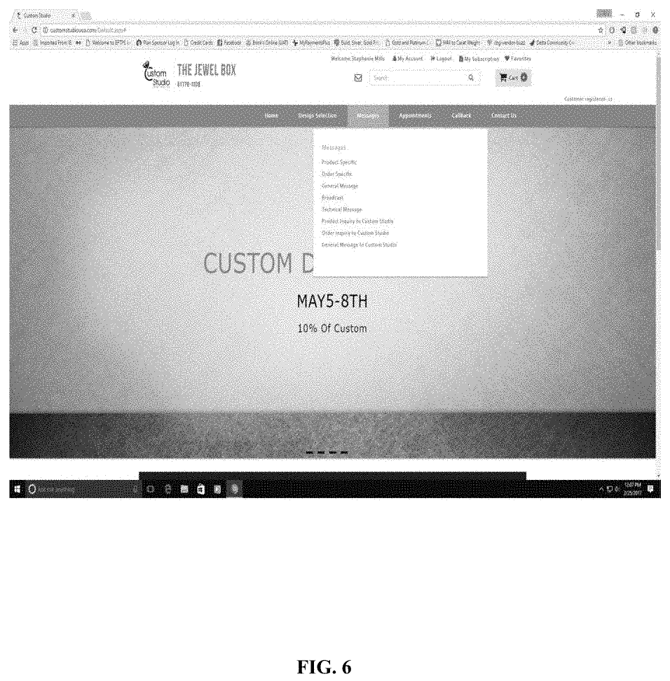

FIG. 6 is a view of the Messages Center Drop Down Menu that the retailer can use to contact a customer or multiple customers directly. The choices in the Messages Center Drop Down Menu include Product Specific, Order Specific, General Message, Broadcast, Technical Message, Product Inquiry to Custom Studio, Order Inquiry to Custom Studio, and General Message to Custom Studio.

FIG. 7 displays the names and contact information for different customers when Broadcast is chosen from the Messages Center Drop Down Menu. In FIG. 7 all the customers' names have been selected.

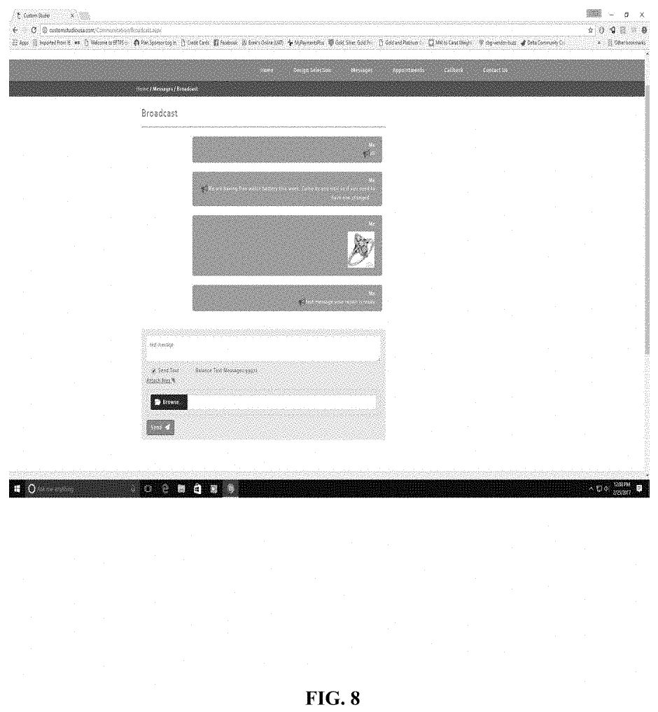

In FIG. 8 broadcast messages are being sent by the retailer to all the customers selected in FIG. 7.

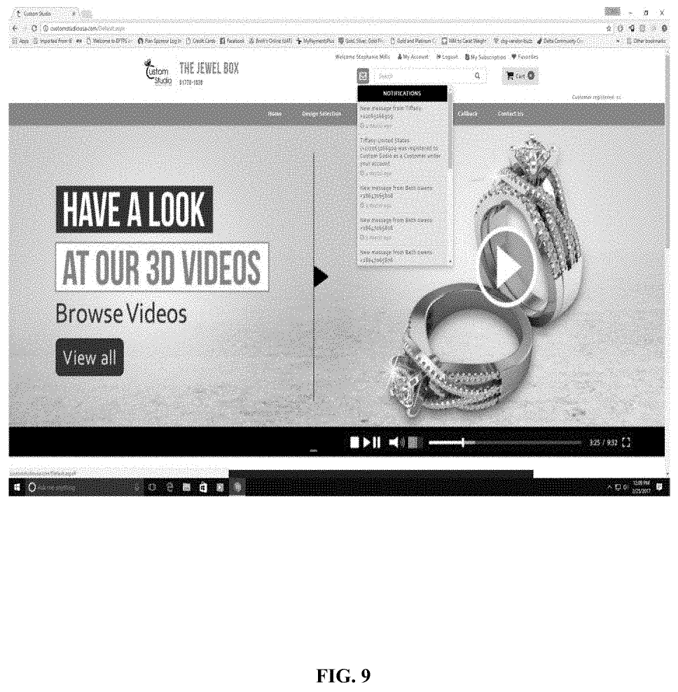

FIG. 9 displays the notification center showing messages from different customers.

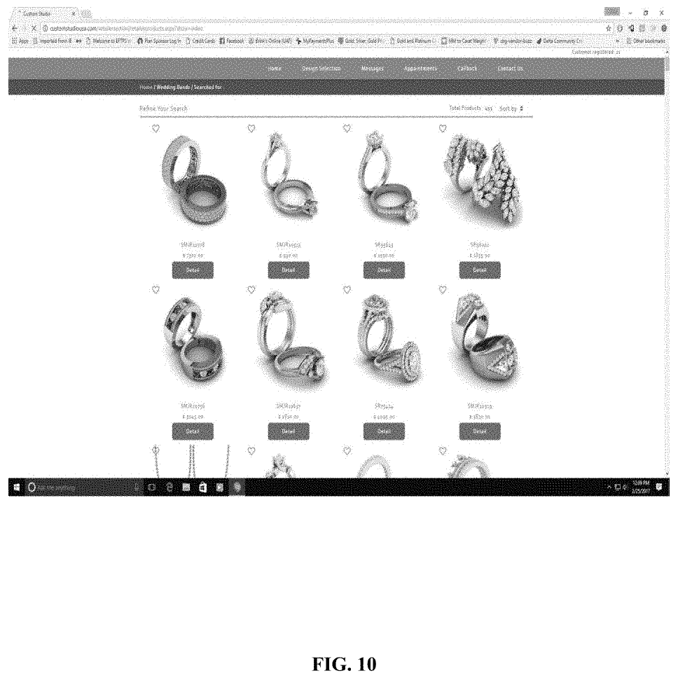

FIG. 10 displays styles and prices for different jewelry designs. In this example rings are displayed showing different colors, shapes, metals, and stones. The customer can click on “Details” to find more information about any design.

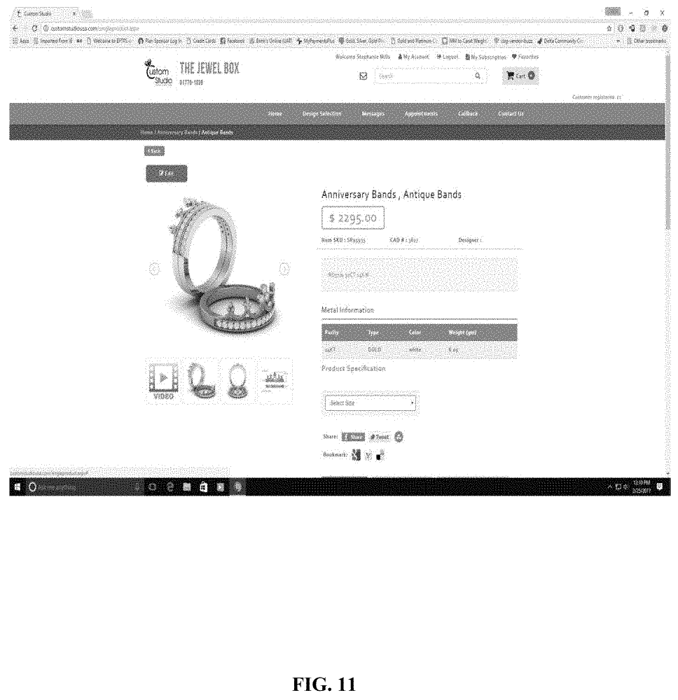

FIG. 11 displays the Details for a particular design of ring. In this example two colors are displayed alongside each other and the customer can examine metal information such as purity, type, color, and weight. In this example the weight and clarity of the diamonds are displayed. The price of the ring, name of the design, Item SKU number, CAD number, and Designer are displayed. In this example there is no Designer associated with the ring. There is an Edit button above the image of the ring.

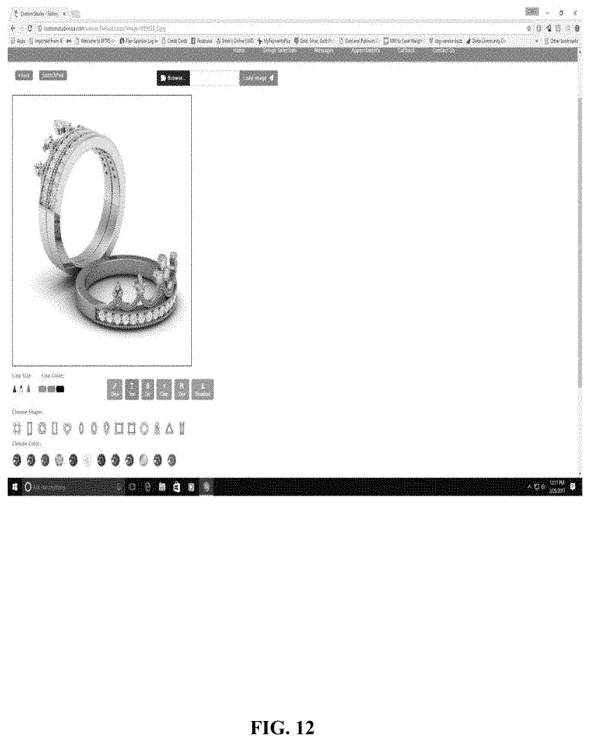

FIG. 12 displays the edit options available to the customer once they have selected the basic jewelry design. The customer may choose the stone (e.g. ruby, emerald, diamond, etc.) and the shape of the stone. The designer can add text to create an engraving or give written instructions to the manufacturer. These are a few examples of the editing options available to customers. They can also, for example, edit the shank shape and size as well as manipulate the metal coloring. The customer may edit existing designs on the platform; use a sketch pad application to create new designs on the platform; or import outside images to the platform, and edit those images directly on the platform using the application.

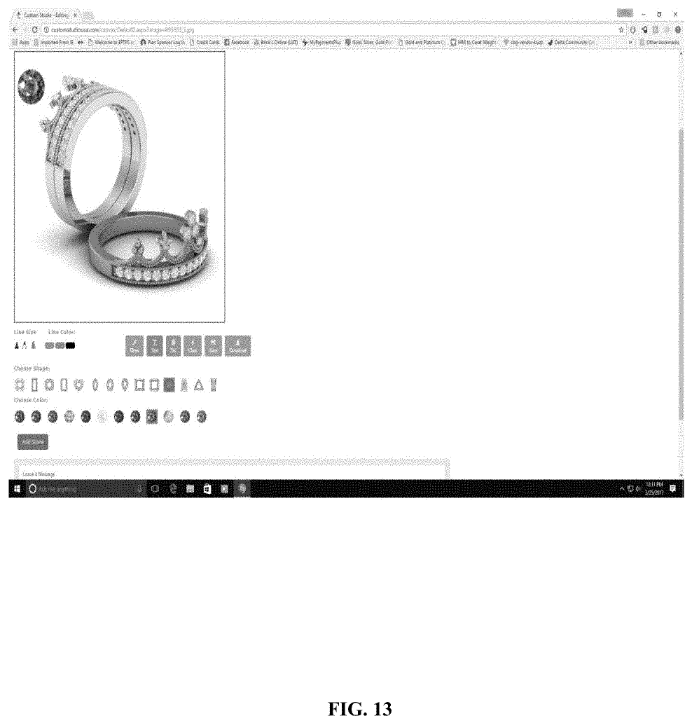

FIG. 13 shows a stone and shape being selected in the edit menu.

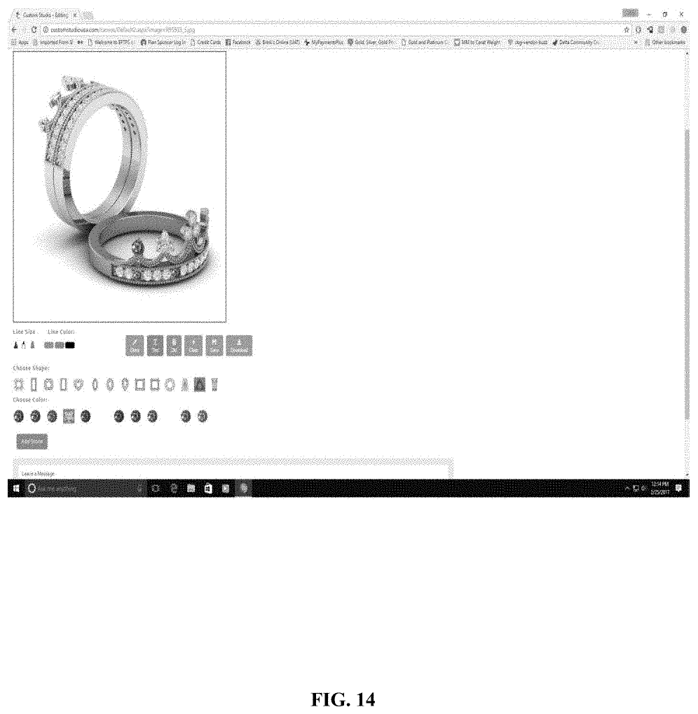

FIG. 14 shows different stones being selected and placed on the rings. The stone sizes can be made larger or smaller using a mouse or touchscreen to adjust the stone to the desired size.

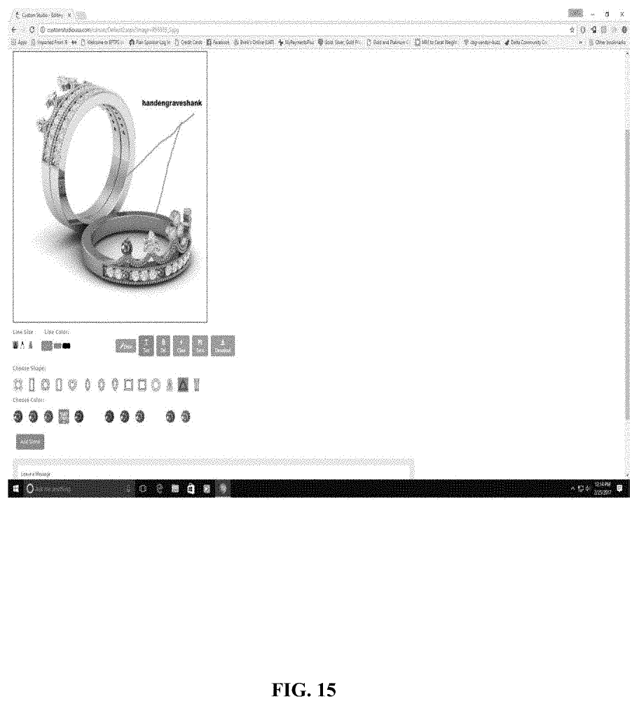

FIG. 15 shows instructions for the manufacturer being added to the ring's design.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

What is claimed is:

1. A design aggregation server comprising:
a processor and a memory, the server configured for:
receiving a plurality of jewelry designs from one or more jewelry designers;
associating characteristics of the plurality of designs into a design database;
receiving an image, input, or design from a retailer or potential customer;
comparing the received image, input, or design with the plurality of designs at the design database; and
providing one or more pricing characteristics to the retailer or the customer based on the comparison.

2. The server of claim 1, wherein the designers are assigned a reference code based on geographic location.

3. The server of claim 2, wherein the customer is assigned a reference code based on geographic location.

4. The server of claim 3, wherein the retailer is assigned a reference code based on geographic location.

5. The server of claim 4, wherein the reference code contains nine digits.

6. The server of claim 5, wherein the first two digits of the reference code represent a country code corresponding with the geographic location of the retailer and the next three digits represent an area code corresponding with the geographic location of the retailer.

7. The server of claim 1, wherein the server is further configured for transmitting the image, input, or design to at least one manufacturer capable of producing jewelry.

8. The server of claim 1, further comprising an application platform having a user interface configured for designing jewelry.

9. A method implemented on at least one server for providing pricing characteristics to retailers, the method comprising:
receiving a plurality of jewelry designs from one or more jewelry designers;
associating characteristics of the plurality of designs into a design database;
receiving an image, input, or design from a retailer or potential customer;
comparing the received image, input, or design with the plurality of designs at the design database; and
providing one or more pricing characteristics to the retailer or the customer based on the comparison.

10. The method of claim 9, wherein the designers are assigned a reference code based on geographic location.

11. The method of claim 10, wherein the customer is assigned a reference code based on geographic location.

12. The method of claim 11, wherein the retailer is assigned a reference code based on geographic location.

13. The method of claim 12, wherein the reference code contains nine digits.

14. The method of claim 13, wherein the first two digits of the reference code represent a country code corresponding with the geographic location of the retailer and the next three digits represent an area code corresponding with the geographic location of the retailer.

15. The method of claim 9, wherein the server is further configured for transmitting the image, input, or design to at least one manufacturer capable of producing jewelry.

16. The method of claim 9, further comprising an application platform having a user interface configured for designing jewelry.

17. A method of facilitating collaboration between designers, manufactures, and retailers for manufacturing and selling jewelry, the method comprising:
receiving a jewelry design created on an application platform interface from a customer or designer;
receiving design specifications through the interface to a design aggregation server from the customer or designer;
communicating the specifications to at least one manufacturer; and
receiving pricing data and a modified specification from the at least one manufacturer,
wherein the modified specification and pricing are communicated to the customer or designer,
wherein a piece of jewelry is manufactured based on the modified specification,
wherein the manufactured piece of jewelry is shipped to the retailer or designer for selling or displaying.

18. The method of claim 17, further comprising coupling to a mobile device or computer capable of rendering the application platform interface.

19. The method of claim 17, further comprising rejecting the design created by the customer on the application platform interface.

20. The method of claim 17, further comprising transmitting the modified specification from the design aggregation server to the designer over the application platform interface.

21. The method of claim 17, wherein the manufactured piece of jewelry is shipped directly to the customer.

22. The method of claim 21, wherein the customer uses the application platform interface to pay for the piece of jewelry.

23. A method of associating terminology with design features of jewelry comprising:
recording search terms from a plurality of users on an application platform interface;
tracking the navigation of each user throughout the application;
recording the final selection of jewelry chosen by each user;
associating the search terms from each user with the design features of the final selection of jewelry chosen by each user;
detecting a pattern of user behavior among the plurality of users; and
creating a database of search terms and correlating the search terms with particular design features of jewelry based on the detected pattern of user behavior.

24. The method of claim 23, further comprising storing the database of search terms on a design aggregation server.

25. The method of claim 23, wherein detecting a pattern of user behavior comprises:
storing a first user's search terms on a design aggregation server;
storing a second user's search terms on the design aggregation server;
storing, on the design aggregation server, design features related to the first user's final selection of jewelry;
storing, on the design aggregation server, design features related to the second user's final selection of jewelry;
comparing design features related to the first user's final selection of jewelry, with design features related to the second user's final selection of jewelry;
determining commonalities between the two users' design features;
comparing the first user's search terms with the second user's search terms;
determining commonalties between the two users' search terms;
determining a correlation between the design feature commonalities and the search term commonalities; and
storing the correlation on the design aggregation server.

26. The method of claim 25, further comprising:
receiving search terms from a third user through the application platform interface, wherein the interface is communicatively coupled to the design aggregation server;
comparing the search terms from the third user against the correlation; and
determining which design features are most relevant to the third user.
